(19) United States
(12) Patent Application Publication
(10) Pub. No.: US 2015/0227698 A1
(43) Pub. Date: Aug. 13, 2015

(54) METHOD, SYSTEM AND COMPUTER PROGRAM PRODUCT FOR CONSOLIDATING HEALTHCARE SMS/MMS MESSAGING TO A MEDICAL RECORD SERVER

(71) Applicant: Sanjeevkumar V Dahiwadkar, Ellicott City, MD (US)

(72) Inventor: Sanjeevkumar V Dahiwadkar, Ellicott City, MD (US)

(21) Appl. No.: 14/611,563

(22) Filed: Feb. 2, 2015

Related U.S. Application Data
(60) Provisional application No. 61/939,443, filed on Feb. 13, 2014.

(51) Int. Cl. G06F 19/00; H04W 4/14; G06F 17/30

(52) U.S. Cl. CPC G06F 19/324; G06F 17/30581; H04W 4/14

(57) ABSTRACT

A system and method for selectively saving SMS/MMS text messages sent via a mobile device between a doctor/nurse and his or her patient to a secure database. The invention provide a mobile application having an intuitive user interface wherein a doctor or nurse can review all text messages sent to or from his or her mobile device, including the content, date, time, sender/receiver phone number and priority level, to determine which text messages contain information worthy of recordation into the individual patient's medical record. The mobile application according to the present invention further provides a means of transmission of selected messages to an Electronic Medical Records (EMR)/Electronic Health Records (EHR) system, and for automatic synchronization of Text Messages with EMR/EHR systems. The mobile application also allows a doctor/nurse to send a message to an individual patient directly from the mobile application. The invention further includes a web-based Text Tracking Plug-in capable of performing the same functions.

### CROSS-REFERENCE TO RELATED APPLICATION(S)

The present application derives priority from U.S. Provisional Patent Application 61/939,443 filed Feb. 13, 2014.

### BACKGROUND OF THE INVENTION

1. Field of the Invention

The present invention relates to a system and method for preserving SMS/MMS text messages, and, more specifically, to a system and method for selectively incorporating healthcare-related SMS/MMS text messages into a patient's healthcare record.

2. Description of the Background

Wireless telephone customers contract with their wireless provider to send and receive text messages on their cellular telephones. Common communications protocols for text messaging include the Short Message Service (SMS) and Multimedia Message Service (MMS). The SMS standard allows users to send messages of up to 160 characters to and from GSM Mobile handsets. The MMS protocol is an extension of the SMS protocol and allows a mobile telephone user to send multimedia data in addition to text. In both cases to text message, a first mobile telephone customer uses the keypad on their mobile telephone to enter a text message, enters a telephone number of a second mobile telephone customer to receive the message, and then sends the message. The second customer can, if the second user's phone is text enabled, read the message on the mobile telephone display and choose to reply by entering a text message and sending the reply to the first user.

Physicians are increasingly making use of SMS/MMS texting via mobile phones or other computer devices to patients, and vice versa. This allows them to stay in contact and check on patients more frequently, as well as to comprehensively monitor a patient's symptoms or the progress of his or her medical condition. Subsequent to the release of a patient from a medical facility, a physician or nurse may want to periodically check their condition. The patient can be contacted via SMS/MMS on the patient's mobile telephone, smartphone (e.g., blackberry, Android-type telephone, iPhone, iPad, etc.), any other form of personal digital assistant (PDA), plus a landline telephone, a personal computer, a laptop computer, and/or any other wireless, wireline, and/or wired apparatus and/or device. The communications can be received on a periodic basis (e.g., hourly, daily, weekly, monthly, etc.), at random times, or at predetermined times, and/or any combination thereof. Little if any of this communication occurs in a HIPAA-secure manner. None of it becomes a part of any permanent record, let alone the patient's medical record. However, in many cases, these doctor-patient communications are subject to and/or legally require protection under HIPAA, and contain information relevant to a patient's health or healthcare that a doctor may want or need to reference in making appropriate and responsible decisions about the treatment of that patient. Moreover, because many patients have easy and immediate access to a mobile device, many, if not most, of these doctor-patient communications occur at or near the time when a patient is actually experiencing the symptoms that he or she relates to the doctor and/or suffering from the condition that the doctor is treating, and therefore such communications are more reliable for treatment purposes than a patient's later statements about the symptoms that he or she experienced in the past.

Accordingly, a need in the art exists for a low cost system capable of consolidating healthcare messaging to an Electronic Medical Records (EMR)/Electronic Health Records (EHR) server. The system and method described herein provide a messaging application plugin for selectively and proactively consolidating SMS/MMS messages from the native text messaging application on a user's portable device to a medical record repository, as well as data-synchronization functionality for selectively importing SMS/MMS messaging from the native text messaging application on the user's portable device to the medical record repository (EMR/EHR system) to help doctors to keep track of important doctor-patient communications. This way important text messages, as identified by the treating doctor, become part of the patient's chart for later reference by the doctor or another healthcare professional.

### SUMMARY OF THE INVENTION

It is, therefore, the primary object of the present invention to provide a method, system, and computer program product for consolidating healthcare text messaging to a medical record server.

It is another object to provide a method, system and computer program product capable of selectively and proactively consolidating SMS/MMS messaging from the native text messaging applications on a plurality of user's portable devices to a medical record repository.

It is another object to provide a method, system and computer program product capable of selectively and periodically consolidating SMS/MMS messaging that have already occurred on multiple portable devices using the native text messaging applications on those users' portable devices into a medical record repository.

These and other objects are herein accomplished by a method, system and computer program product for allowing a treating doctor/nurse to view and select individual text messages for recordation through an easy user interface, for transmission of selected messages to an Electronic Medical Records (EMR)/Electronic Health Records (EHR) system, and for automatic synchronization of Text Messages with EMR/EHR systems.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is an illustration of the hardware architecture according to the present invention.

FIG. 2 is a screenshot of the login screen to the RxOffice™ TextSave Mobile Application for a PDA 12 according to the present invention.

FIG. 3 is a screenshot of the login screen to the RxOffice™ TextSave Mobile Application for a PDA 12 according to the present invention for password retrieval in case it is forgotten.

FIG. 4 is a screenshot of the mode selection screen of the RxOffice™ TextSave Mobile Application for a PDA 12 according to the present invention.

FIG. 5 is a screenshot of the ‘Select Messages’ screen of the RxOffice™ TextSave Mobile Application for a PDA 12 according to the present invention.

FIG. 6 is a screenshot of the ‘Select Messages’ screen of the RxOffice™ TextSave

Mobile Application for a PDA 12 according to the present invention, where one individual messages has been selected.

FIG. 7 is a screenshot of the message composition screen of the RxOffice™ TextSave Mobile Application for a PDA 12 according to the present invention.

FIG. 8 is a screenshot of the user interface of the web-based Text Tracking Plug-in according to the present invention as the user prepares to import a local SMS database.

FIG. 9 is a screenshot of the user interface of the web-based Text Tracking Plug-in according to the present invention showing the EMR/EHR for an individual patient.

FIG. 10 is a flow chart of the synchronization process for synchronizing text messages using existing text received on mobile devices 12.

FIG. 11 is a flow chart of the synchronization process when composing a new text from mobile devices 12.

### DETAILED DESCRIPTION OF THE PREFERRED EMBODIMENT

The present invention is a computer program product, system and method for selectively and proactively consolidating SMS/MMS messaging from the native text messaging application on multiple users' portable computing devices in real time as the messaging occurs, as well as selectively synchronizing and periodically consolidating SMS/MMS messaging that has already taken place, all to a common medical record repository or Electronic Medical Records (EMR)/Electronic Health Records (EHR) system.

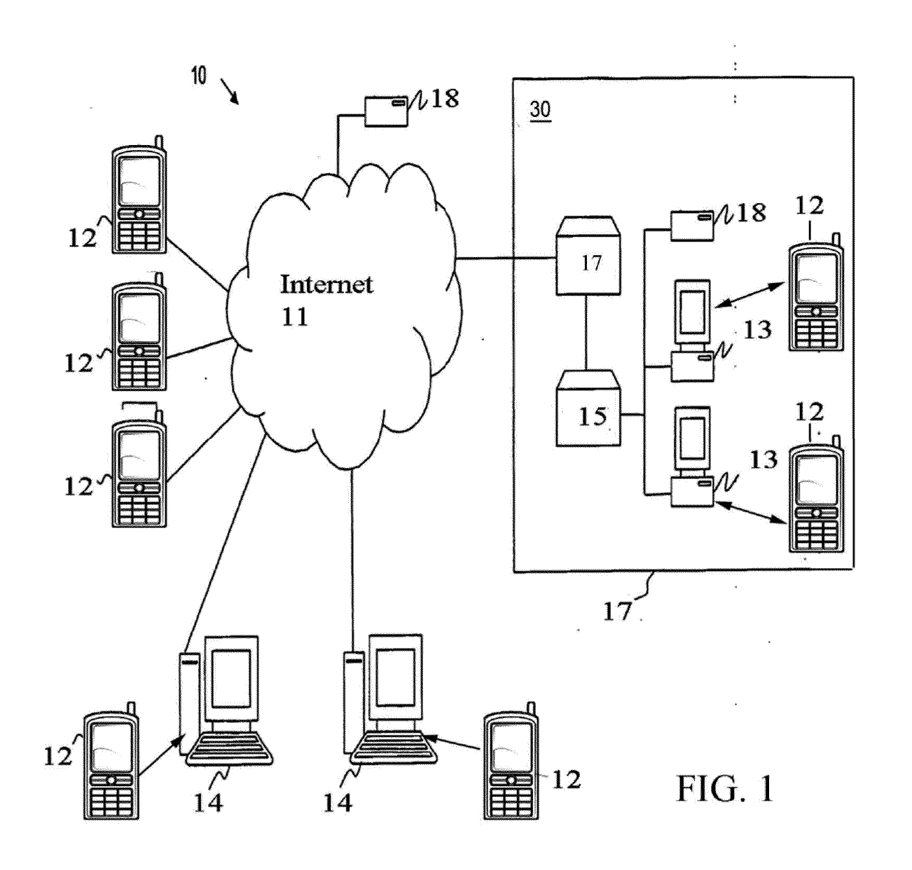

FIG. 1 is an illustration of the hardware architecture, which includes a distributed client-server hardware architecture as typically maintained at a healthcare facility. At the physician/nurse level, the service is delivered through a plurality of portable communications devices (PDAs) 12, which may be any text-messaging capable device including PDAs, cell phones and the like, or laptop/stationary personal computers having a native text-messaging application. One skilled in the art will understand that other text-capable devices may include point-of-sale devices (POS), point-of-interaction device (POI), or the like. PDAs 12 are capable of selectively and proactively consolidating SMS/MMS messaging in real time as messages are sent via their native text messaging application, into a medical record repository 18 resident in a healthcare client-server network 30. PDAs 12 are also capable of selectively consolidating accumulated SMS/MMS messaging from their native text messaging application to medical record repository 18 by synchronization through client workstations 13, 14, each of which may be any conventional computer. Groups of client workstations 14 are connected to client-server network 30 via an internet backbone, while some client workstations 13 are locally connected directly to the client-server network 30. The client-server network 30 includes a web-enabled server 15 connected to the internet 11 through a secure gateway 17. Secure gateway 17 hosts a resident routing database which stores data authentication and verification information (usernames and passwords) correlating to registered participants. The internet or World Wide Web 11 provides a known system for interconnecting PDAs 12 and client workstations 14 in a communicating relationship. However, other networks may be used, such as satellite networks, public switched telephone networks, WiFi networks, WiMax networks, cellular networks, and any other public, private, or dedicated networks that might be used to interconnect devices for transfer of data.

Secure communication lines 19 are used between PDAs 12, client workstations 13 and client-server network 30 so that private data remains so. Moreover, the secure gateway 17 hosting a resident routing database also provides a secure gateway which ensures security of data as well as operating compatibility between the client-server network 30 and the internet 11.

The medical records repository 18 comprises a database server in communication with non-transitory computer memory, which may be local or any distributed storage array. The database server runs database management software to provide database services to client-server network 30. Database management systems frequently provide database server functionality, and some DBMSs (e.g., MySQL) rely exclusively on the client-server model for database access.

Thus, medical records repository 18 preferably hosts a network database on the non-transitory computer memory, preferably an SQL server database, running MySQL (a popular open source database). Other examples of suitable database servers are Oracle™, DB2™, Informix™, Ingres™, and SQL Server™. As shown in FIG. 1 the medical records repository 18 may be a part of the local client/server environment 30 or may be a cloud-based repository 18 connected directly to the internet 11.

The secure gateway 17 with routing database may be a Citrix Access Gateway®, or other suitable secure data access solution that provides administrators via local workstations 13 with software and data-level control while providing nurses/physicians using PDAs 12 with remote access for securing the delivery of data to medical records repository 18.

The software method of the invention, delivered through the foregoing network, enables nurses/physicians using PDAs 12 to selectively consolidate healthcare-related text messages to the medical record repository 18, all as described further herein. The software comprises a modular array of open-architecture software, including a RxOffice™ TextSave Mobile Application 100 resident on PDAs 12, and web-based RxRxOffice™ TextSave Data Sync Application 200 resident on client workstations 13, both described below.

The RxOffice™ TextSave Mobile Application 100 is locally resident on PDAs 12 and is a multiprotocol Mobile Instant Messaging (MIM) messaging client applet configured to run on mobile devices and to provide protocol support for the native messaging client (which must also be running in resident memory), as well as a user interface. The RxOffice™ TextSave Mobile Application 100 is designed to selectively and securely save locally-generated text messages into the medical records repository 18 on the network database, tagged to the respective Electronic Medical Records (EMR)/Electronic Health Records (EHR) of the appropriate patient, all in real time as they are sent directly from PDAs 12.

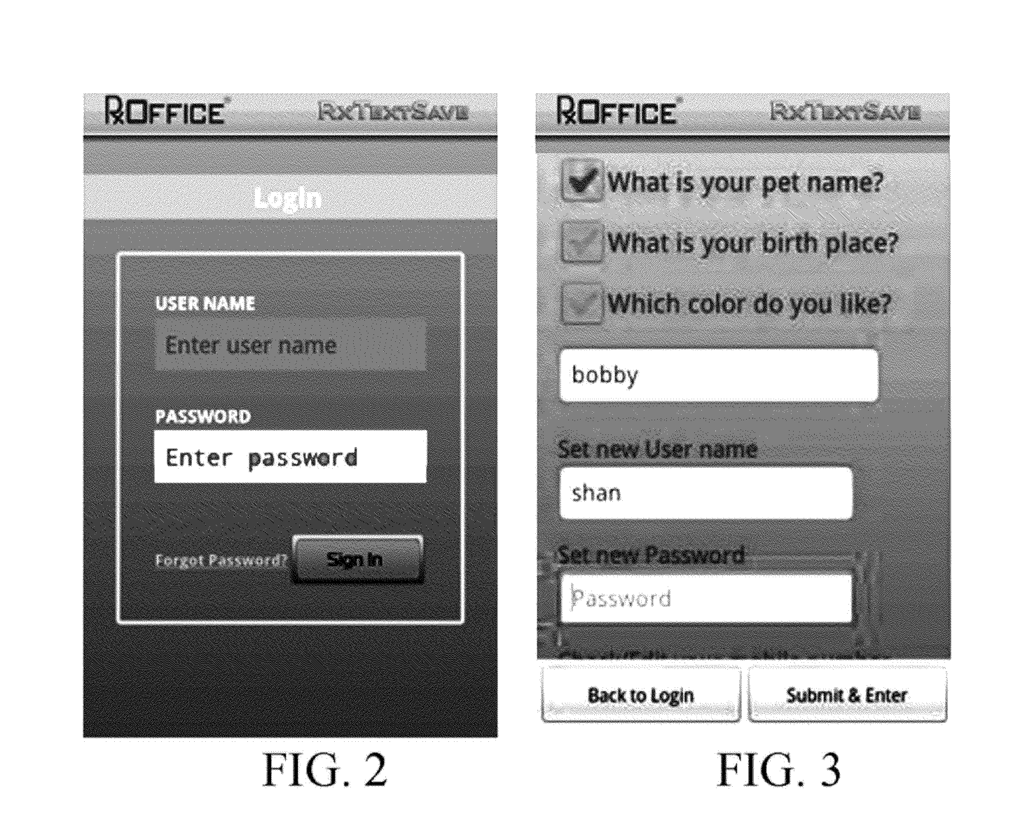

FIG. 2 is a screenshot of the login screen for PDA 12 for RxOffice™ TextSave Mobile Application 100 by which nurses/physicians securely log-in into the mobile application. The RxOffice™ TextSave Mobile application 100 requires a username and password to ensure the security of the messages shared between doctor and patient.

FIG. 3 is a screenshot of the login screen for PDA 12 for RxOffice™ TextSave Mobile Application 100 for password retrieval in case it is forgotten. The user can set preferences for the questions of their choice at the time of sign-up. The user will be prompted to answer these questions upon signing into the RxOffice™ TextSave Mobile Application 100 for the first time on a given device to further ensure data security. Once the device recognizes the user by his or her answers, this process will be skipped for ease and speed of login.

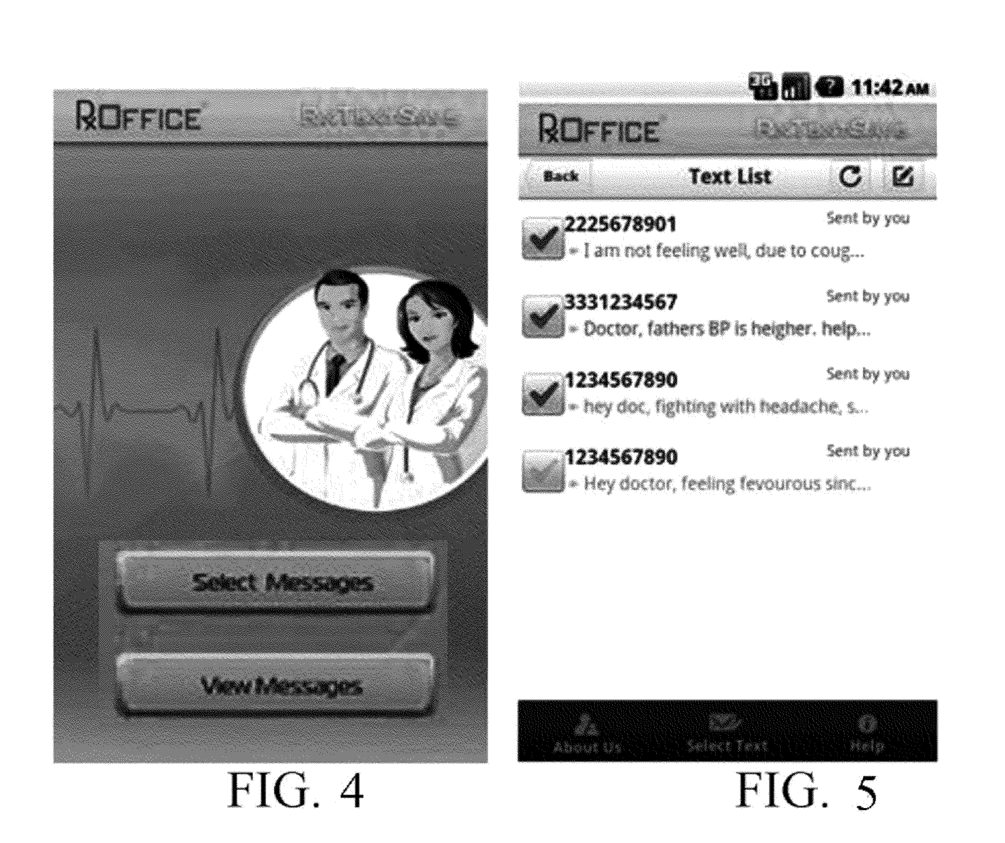

Upon securely logging in to the RxOffice™ TextSave Mobile Application 100, the user will see the mode selection screen, a screenshot of which is depicted in FIG. 4. On this screen, the user can select between the options of 1) designating specific text messages to be saved for later (designated as the ‘Select Messages’ option), or 2) viewing messages already saved (designated as the ‘View Messages’ option).

On selecting the ‘Select Messages’ option, a list of all Text messages from the mobile phone is displayed as shown in FIG. 5. The display shows a list of SMS messages from the SMS database on the mobile device native messaging platform and displays them in a cross-platform messaging interface in list format as in FIG. 5. The doctor/nurse can easily scroll through all Text messages, organized by time of receipt, and displayed with the full area code and number of the sender and the first few characters of the message for identification.

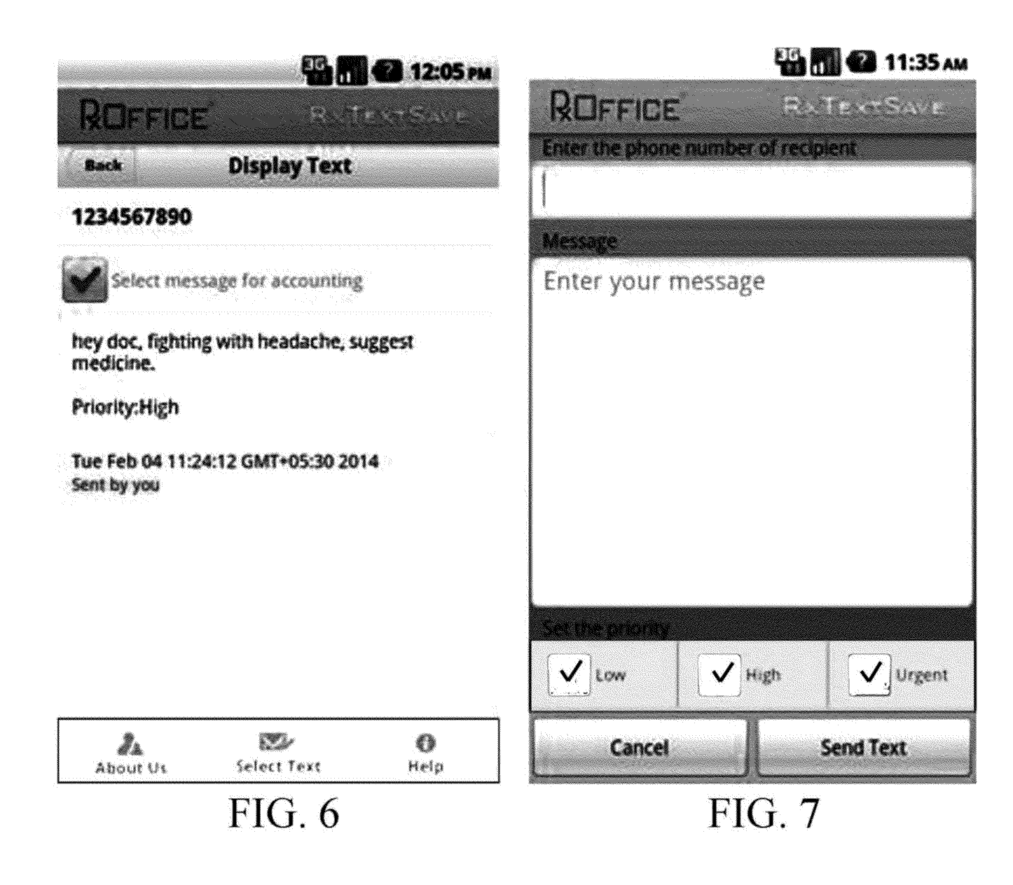

As shown in the screenshots of FIGS. 5 and 6, the doctor/nurse manually can select Text messages directly from the cross-platform messaging interface on their PDA 12 to be synced with the EMR/EHR repository 18 on the network database by simply activating the check box to the left of the text message in the list. As further shown in FIG. 6, the doctor/nurse can view the entire message, the date and time that the message was received by the doctor's/nurse's mobile device, and the priority of the message, as well as the number from which the message was sent, by clicking on the message from the list display as depicted in FIG. 5. With this information, the doctor/nurse can determine which text messages should be recorded in their patients' medical records. When the user has finished selecting those messages that he or she determines are appropriate for transmission to the EMR/EHR medical records repository 18 on the network database, the application automatically filters and transmits the messages selected by the doctor/nurse to the EMR/EHR repository 18.

The RxOffice™ TextSave Mobile Application 100 also provides a “mail gateway” application by which doctors and nurses can compose and send a Text message to a patient directly. The mail gateway application communicates with the native SMS application and allows users to send and receive SMS messages, to/from another telephone number.

FIG. 7 is a screenshot of the RxOffice™ TextSave Mobile Application 100 mail gateway application composition screen. The physician/nurse simply enters the phone number for their patient, sets the text priority, enters the message, and sends. The priority designation provides doctors a way to prioritize/categorize text messages for later follow-up. The RxOffice™ TextSave Mobile Application 100 mail gateway application composition screen allows the doctor/nurse to immediately send a message to the patient upon reviewing those messages that the doctor/nurse has received from the patient, and determine which of those are worth saving in the patient's file and/or responding to, without having to log out of the application. Like any message sent from the doctor's/nurse's mobile phone, messages sent by the doctor/nurse from the RxOffice™ TextSave Mobile Application 100 mail gateway application composition screen can be viewed on the list display of Text messages, as shown in FIG. 5, for possible selection for syncing with the EMR/EHR repository 18.

The RxOffice™ TextSave Mobile Application 100 may be authored in the Java programming language for the Android® mobile platform or in Apple's Objective-C to run natively on the iPhone® operating system.

As indicated above the present system employs a secure gateway 17 hosting a resident routing database. The routing database is an Internet Routing Registry (IRR) containing a hierarchical permissions scheme defining administrator and individual user permissions for accessing, adding to and changing the Electronic Medical Records (EMR)/Electronic Health Records (EHR) medical records repository 18 on the network database. All objects in the IRR database contain attribute-value pairs, which state which users have which permissions in regard to each type of medical records repository object. Consolidation of the SMS/MMS messaging from each user's devices 12, 13, 14 is selective, subject to the routing database.

In addition to proactively consolidating SMS/MMS messaging from user's PDA 12 to the Electronic Medical Records (EMR)/Electronic Health Records (EHR) medical records repository 18 on the network database, the present system also includes a web-based Text Tracking Plug-in to transfer Text Messages from PDAs 12 onto any web-enabled system including local computers 13, 14 (FIG. 1). To accomplish this, the system relies on a SmsPlugin application, e.g., a thin-client front end that is downloaded and installed into the local computer's 13, 14 existing web browser.

Once the web-based Text Tracking Plug-in is downloaded and installed, similar to FIGS. 2-3 above the user logs into the SmsPlugin application. This engenders the screen shown in FIG.

8, which as shown at top allows the user to select and import a local SMS database of any PDA 12 connected to that local computer 13, 14. For this the SmsPlugin application also requires a synchronization cable (Mobile-PC) connection between PDA 12 and local computer 13, 14. Once this is connected the PDA 12 appears as a remote hard drive to the local computer 13, 14. The SMS database on the PDA 12 can be located and identified using the SmsPlugin application's user interface. The user uses the browse button to look for the database file stored in local computer 13, 14, and the import button to import the file into the SmsPlugin application.

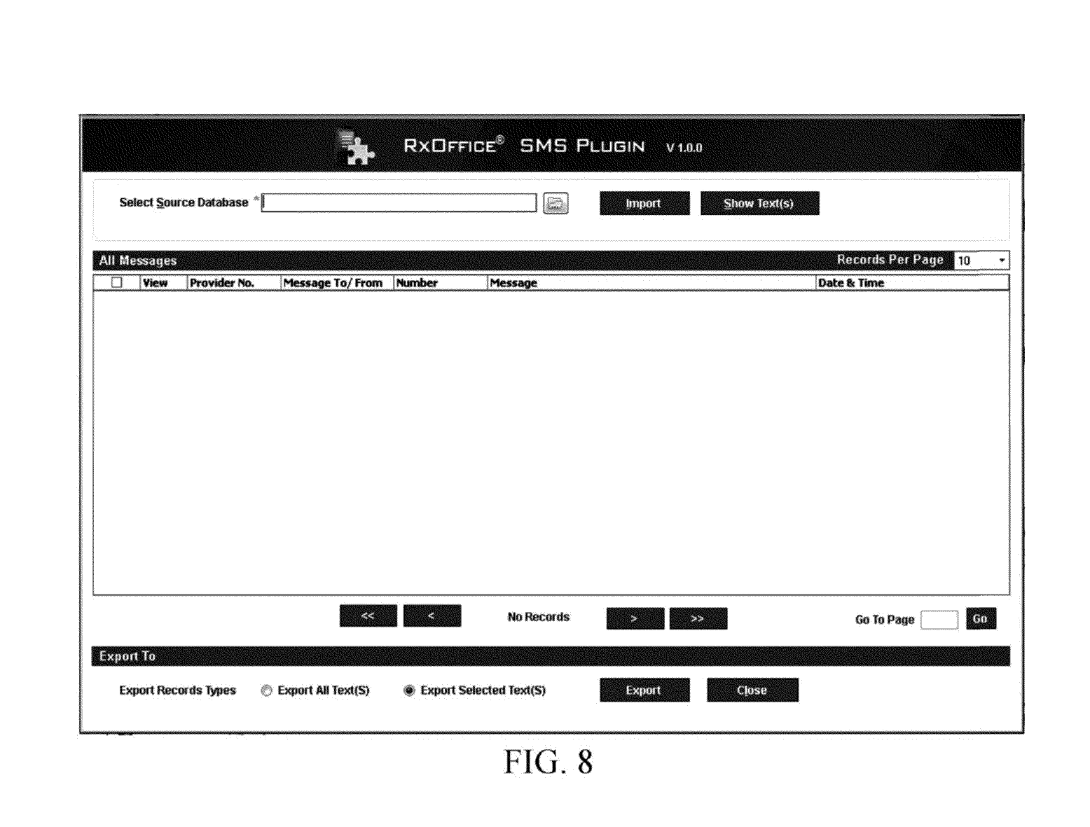

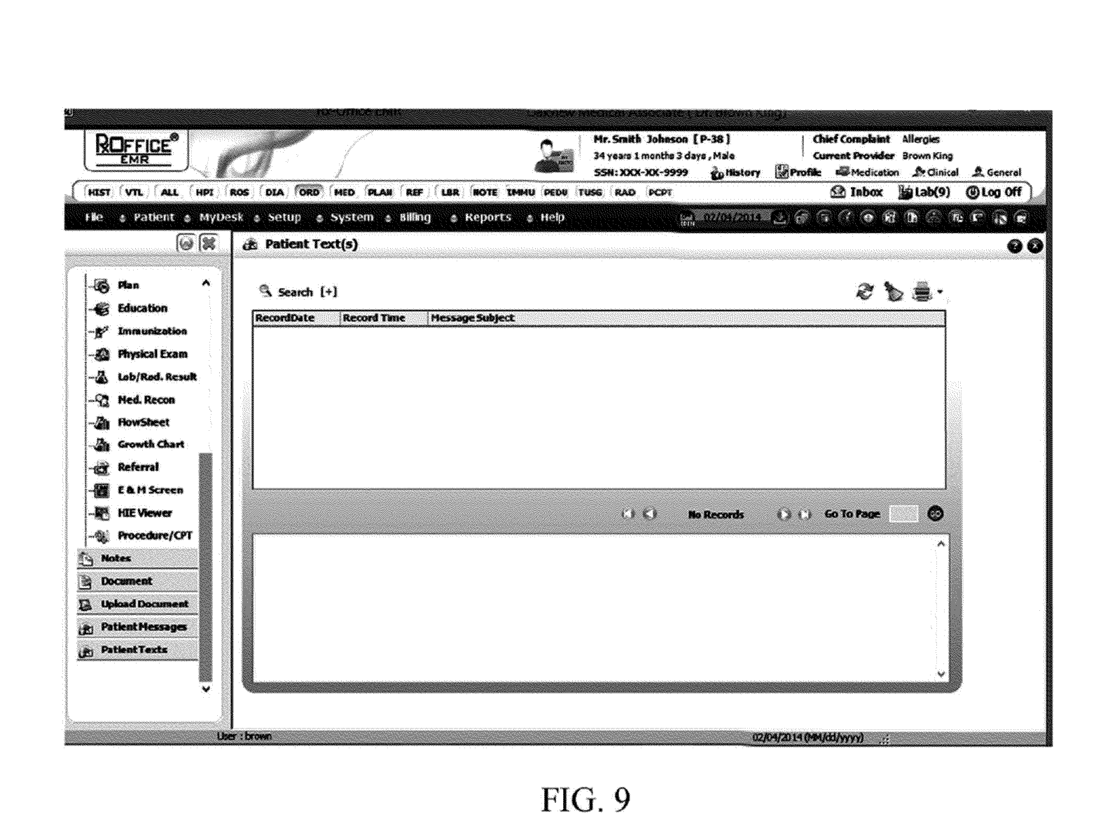

Once file has been imported, the user clicks on “Show Texts”, as shown in FIG. 8, to show the contents of the imported file, which will display a list similar to FIG. 5 with details of message senders (patient/provider cell no.), message received from (patient/provider cell no.), and message descriptions along with date and time on which the communication was sent. As per user wish the record count of all messages can be adjusted using records per page number. All text messages are encrypted at the time of storage and decrypted at the time of retrieval.

Once the SMS database has been selected and imported to the local computer 13, 14, it or selected messages can be re-exported into an Electronic Medical Records (EMR) or any other system using this plug-in. As in FIG. 5, the SmsPlugin application user interface allows a user of that application to select individual Text messages for EMR/EHR export. The SmsPlugin application provides a separate user interface to export the SMS database file now resident on local computer 13, 14 into the appropriate place in the Electronic Medical Records (EMR)/Electronic Health Records (EHR) system. By selecting export an Export Screen is displayed, similar to that shown in the screenshot of FIG. 5. Again, the user can export All SMS(s) text messages, or selected SMS(s) text messages.

Finally, the present system also provides a synchronization application to automatically synchronize messages residing on PDAs 12 and/or local computers 13, 14 to the Electronic Medical Records (EMR)/Electronic Health Records (EHR) system or other data repository.

Two separate synchronization processes are used, one for synchronizing Text Messages using existing Text Messages received on mobile device PDAs 12, and one for Synchronizing Text Messages when composing new Text from mobile devices 12.

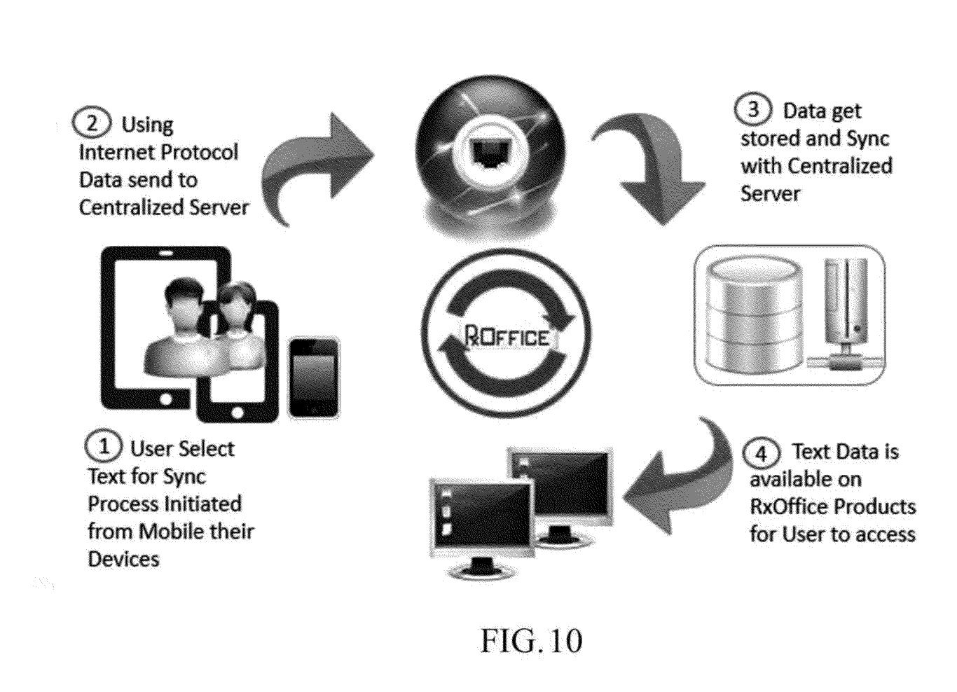

FIG. 10 is a flow chart of the synchronization process for synchronizing Text Messages using existing text received on mobile device PDAs 12. At step 1 the user selects Text for the Synchronization Process (initiated from their PDA 12). At step 2, using Internet Protocol, the SMS data is sent to centralized server 15. At step 3 the data is stored and synchronized with the centralized server 15, and at step 4 the text data is available for access.

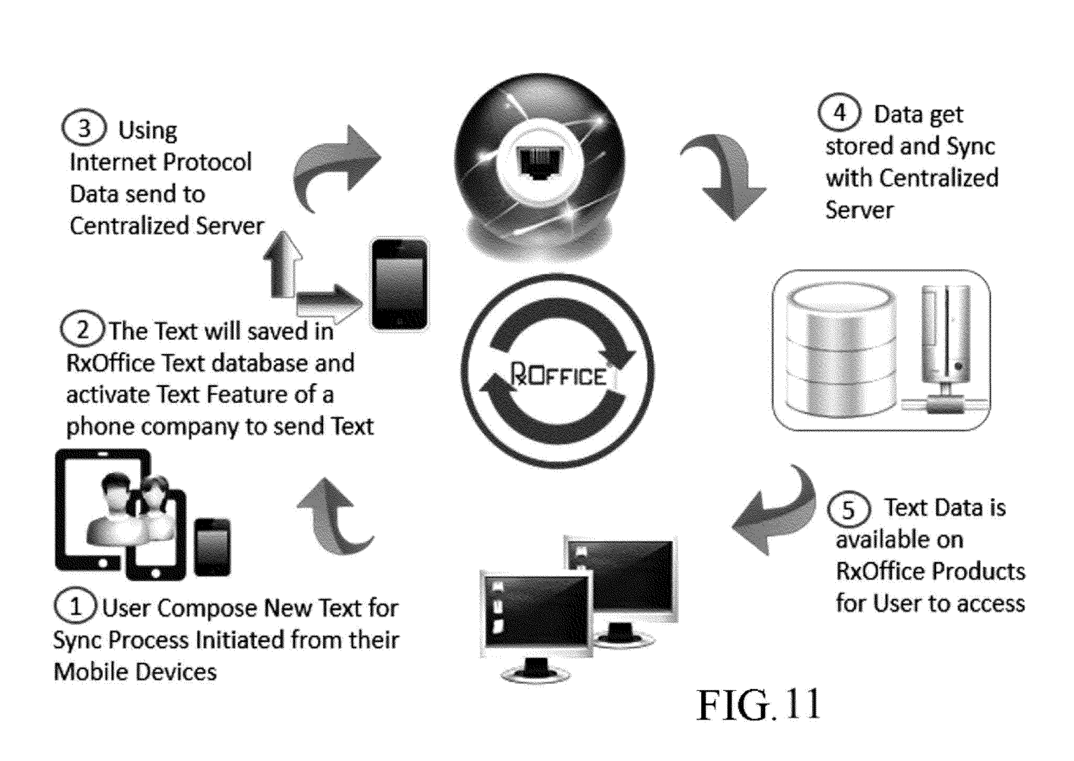

FIG. 11 is a flow chart of the Synchronization Process when composing new Text from mobile devices 12. At step 1 the user composes a new Text Message from their mobile device PDA 12. At step 2 the text message is sent from the user's native text messaging program. At step 3, using Internet Protocol, the SMS data is sent to centralized server 15. At step 4 the data is stored and synchronized with the centralized server 15, and at step 5 the text data is available for access.

It should now be apparent that the above-described invention provides an improved system capable of selectively and proactively consolidating SMS/MMS messaging from the native text messaging application on a user's portable computing device to a medical record repository. The system also selectively and periodically consolidates SMS/MMS messaging that has already occurred using the native text messaging application on a user's portable computing device to a medical record repository.

This has been a description of the present invention and, the preferred embodiment of the present invention, as well as various alternate embodiments of the present invention.

We claim:

1. A system for automatically saving mobile text messages to an electronic medical database, comprising:
a medical records database;
a client-server network, the client-server network further comprising
a web-enabled programmable computer server having non-transitory computer memory and hosting a routing database thereon, said programmable host computer being connected to a communications network and running database management software to provide database services between the client-server network and said medical records database;
a network of client workstations and mobile devices each having non-transitory computer memory and each being connected to said web-enabled server using secured communications lines, said client workstations and mobile devices running application software comprising computer instructions stored on said non-transitory computer memory for viewing, selecting, and managing text messages by a user interface, which is part of the application software run by the client workstations and mobile devices, the user interface being configured to allow a user to view text messages from SMS databases on said mobile devices and to select individual text messages from said SMS databases for transmission to said database management software.

2. The system according to claim 1, further comprising local synchronization application software on the non-transitory computer memory of each remote client workstation for viewing, selecting, and managing text messages for synchronization from one of said remote PDA devices onto said client workstation by a user interface, the user interface being configured to allow a user to view text messages from SMS databases on said selected mobile device and to select individual text messages from said SMS databases for synchronization to said remote client workstation.

3. The system according to claim 1, wherein said routing database comprises permissions for each said remote client workstation and each said mobile device for viewing, adding to and changing said medical records repository.

4. The system according to claim 1, wherein said user interface is configured to allow a user to select text messages from said SMS databases for transmission to said database management software in realtime.

5. The system according to claim 1, wherein said user interface is configured to allow a user to select previously-sent text messages from said SMS databases for transmission to said database management software.

6. A method of managing and storing text messages sent from or received by a mobile device to one or more healthcare records, comprising:
eliciting logon credentials from a user;
displaying a plurality of text messages sent from or received by said mobile device in list format;
allowing said user to select individual ones of said plurality of text messages;
transmitting one or more of said plurality of text messages to an electronic medical records repository.

7. A computer system for consolidating SMS/MMS messages from a plurality of portable computing devices to a common medical record repository, comprising:
a client-server network comprising a web-enabled server hosting a routing database and a medical records database, and running database management software to provide database access services relative to said medical record database;
a plurality of client workstations in network communication with said web-enabled server, said client workstations each having non-transitory computer memory and each having first application software comprising computer instructions stored on said non-transitory computer memory for selectively synchronizing and periodically consolidating SMS/MMS messaging that has already taken place, all to said common medical record repository; and;
a plurality of portable user devices in network communication with said web-enabled server, said portable user devices each having non-transitory computer memory and each having second application software comprising computer instructions stored on said non-transitory computer memory for selectively synchronizing and periodically consolidating SMS/MMS messaging to said common medical record repository in real time.

8. The computer system for consolidating SMS/MMS messages from a plurality of portable computing devices to a common medical record repository, according to claim 7, further comprising third application software on the non-transitory computer memory of each of said plurality of client workstations comprising computer instructions stored on said non-transitory computer memory for selectively synchronizing and periodically consolidating SMS/MMS messaging on one of said portable devices that has already taken place, all to said common medical record repository, when said portable device is connected by a cable connector to one of said plurality of client workstations.

9. The computer system for consolidating SMS/MMS messages from a plurality of portable computing devices to a common medical record repository, according to claim 7, wherein said second application is a multiprotocol Mobile Instant Messaging (MIM) messaging client applet configured to run on mobile devices.

10. The computer system for consolidating SMS/MMS messages from a plurality of portable computing devices to a common medical record repository, according to claim 7, wherein said third application is an SMS plugin application thin-client front end that is downloaded and installed into the plurality of client workstation existing web browsers.

11. The computer system for consolidating SMS/MMS messages from a plurality of portable computing devices to a common medical record repository, according to claim 7, wherein said routing database comprises permissions for each said remote client workstation and each said mobile device for viewing, adding to and changing said medical records repository.
